(19) United States
(12) Patent Application Publication
(10) Pub. No.: US 2005/0034072 A1
(43) Pub. Date: Feb. 10, 2005

(54) Method and system for documenting and processing intellectual assets

(75) Inventor: David M. Sherr, Moraga, CA (US)

Correspondence Address: FOLEY & LARDNER, 150 EAST GILMAN STREET, P.O. BOX 1497, MADISON, WI, 53701-1497, US

(73) Assignee: Charles Schwab & Co., Inc.

(21) Appl. No.: 10/635,927

(22) Filed: Aug. 6, 2003

(51) Int. Cl. G06F 17/00

(52) U.S. Cl. 715/534

(57) ABSTRACT

The method and system of the disclosure enable the creation of hand-written and electronic documentation as well as the processing of the created electronic document. The method simultaneously creates an electronic record of a hand-written document as the document is written and processes the electronic record within a computer system. The method includes receiving electronic information relating to a document from a device, receiving certification information relating to the document and associated with a second party, storing the electronic information relating to the document and the certification information in an electronic record, and making the electronic record accessible for retrieval over a network. The device creates the electronic information at the same time a hand-written record of the document is created. The hand-written record of the document is created by a first party.

### FIELD OF THE INVENTION

The present invention relates generally to computerized systems and methods used to store and catalog information. More particularly, the present invention relates to a method and system for documenting and processing intellectual assets.

### BACKGROUND OF THE INVENTION

Companies, or even individuals, engaged in the development of new ideas are faced with the important task of documenting ideas in a way that saves descriptions of the ideas as well as organizes them. Such documentation systems can be referred to as intellectual property (IP) documentation systems because they document intangible assets or intellectual property. These systems can be particularly important in the corporate setting where numbers of employees are developing new ideas in a wide range of similar or different subject areas.

Recording information about innovations can serve a variety of purposes, such as, sharing ideas among other employees of the company and recording evidence of when an innovation was conceived and what the innovation was. Yet another purpose for recording innovations can be to facilitate the process of preparing, filing, and prosecuting patent applications and/or to document important company trade secrets.

Different individual innovators and different companies utilize a wide range of techniques for recording innovations. For example, some innovators write a description of their innovations in a lab notebook or on sheets of paper. Some companies require innovators to complete standard forms to have the innovation considered for inclusion in a patent application. A patent review committee, a legal department, or some other company administrator often reviews the standard forms to determine whether patent protection and other intellectual property protection are desired.

The process of receiving and analyzing information about innovations can be time-consuming and inefficient. Conventional systems and methods generally require a great deal of human interaction, including tasks such as making numerous telephone calls and searching for relevant documentation. The slow and cumbersome nature of these conventional systems and methods increases the amount of time it takes to determine the viability and desirability of an innovation, prepare and file patent applications for the innovation, or implement the innovation. Furthermore, innovators can be deterred from even participating in the innovation disclosure process because they view the process as time-consuming and inefficient.

The conventional technique of recording ideas or inventions using engineering notebooks is a good example of how conventional techniques can be slow and inefficient. One limitation to engineering notebooks is that, because such notebooks are physical assets, they can be lost or damaged. Further, a reviewer often needs to take the engineering notebook away from the possession of the inventor to be able to examine the invention recorded in the notebook. There is also a time delay associated with exchanging and reviewing ideas in engineering notebooks. Typically, only one reviewer can study an idea in a notebook at a time. Further, the notebook is reviewed in a serial fashion. The first reviewer does not have the opportunity to see comments made by a later reviewer without slowing the review process down even further.

Systems exist that utilize electronic techniques to improve upon conventional systems like the engineering notebook. For example, some companies scan documents prepared by inventors into a database. If possible, character recognition programs are used to convert handwriting into computer-readable text. Other companies have established computerized authoring tools for inventors to record their inventions directly into an application that saves and organizes them.

Such attempts at overcoming the limitations of conventional intellectual property documentation systems do not simultaneously create electronic (“soft”) and physical (“hard”) copies of an invention disclosure. Instead, these systems add yet another layer of complexity to the invention documentation process. In the scanning systems, for example, additional time is required to scan the documents and then review the computerized document for errors (e.g., character recognition errors).

Thus, there is a need for an improved method and system for documenting and processing intellectual assets. Further, there is a need to simultaneously create electronic (“soft”) and physical (“hard”) copies of an invention disclosure. Even further, there is a need to provide an end to end intellectual property documentation system that records, catalogs, and makes invention description documents accessible to people having the need to know.

### SUMMARY OF THE INVENTION

According to an exemplary embodiment, a method and a system enable the creation of hand-written and electronic documentation as well as the processing of the created electronic document. For example, the method simultaneously creates an electronic record of a hand-written document as the document is written and processes the electronic record within a computer system. The method includes receiving electronic information relating to a document from a device, receiving certification information relating to the document and associated with a second party, storing the electronic information relating to the document and the certification information in an electronic record, and making the electronic record accessible for retrieval over a network. The device creates the electronic information at the same time a hand-written record of the document is created. The hand-written record of the document is created by a first party.

According to another exemplary embodiment, a documentation system includes a digital pen configured to dispense ink while also electronically recording writing information and a computer. The computer includes programmed instructions to receive electronically recorded writing information from the digital pen and create an electronic document and programmed instructions operable to allow editing and annotations to the electronic document until certification information is received corresponding to the electronic document.

According to another exemplary embodiment, an intellectual property documentation system includes an inventor input device configured to write using a writing fluid and electronically record writing information, a first computer, a second computer, and an interface. The first computer is operable to receive the electronically recorded writing information from the inventor input device and has programmed instructions configured to create a modifiable electronic record from the electronically recorded writing information. The second computer is operable to communicate with the first computer and has programmed instructions to receive certification information and make the electronic record read only once the certification information is received. Further, the second computer has programmed instructions to index the electronic record for retrieval from a database. The interface is in communication with the database such that a third computer can search a plurality of electronic records on the database and view a selected electronic record.

Other features and advantages of the present invention will become apparent to those skilled in the art from the following detailed description and accompanying drawings. It should be understood, however, that the detailed description and specific examples, while indicating exemplary embodiments of the present invention, are given by way of illustration and not limitation. Many modifications and changes within the scope of the present invention may be made without departing from the spirit thereof, and the invention includes all such modifications.

### BRIEF DESCRIPTION OF THE DRAWINGS

The exemplary embodiments will hereafter be described with reference to the accompanying drawings.

FIG. 1 is a flow diagram depicting exemplary operations in an intellectual property (IP) documentation system.

FIG. 2 is a diagrammatic representation of an intellectual property (IP) documentation system in accordance with an exemplary embodiment.

FIG. 3 is a diagrammatic representation of a example hardcopy page used in the IP documentation system of FIG. 2 according to an exemplary embodiment.

### DETAILED DESCRIPTION OF EXEMPLARY EMBODIMENTS

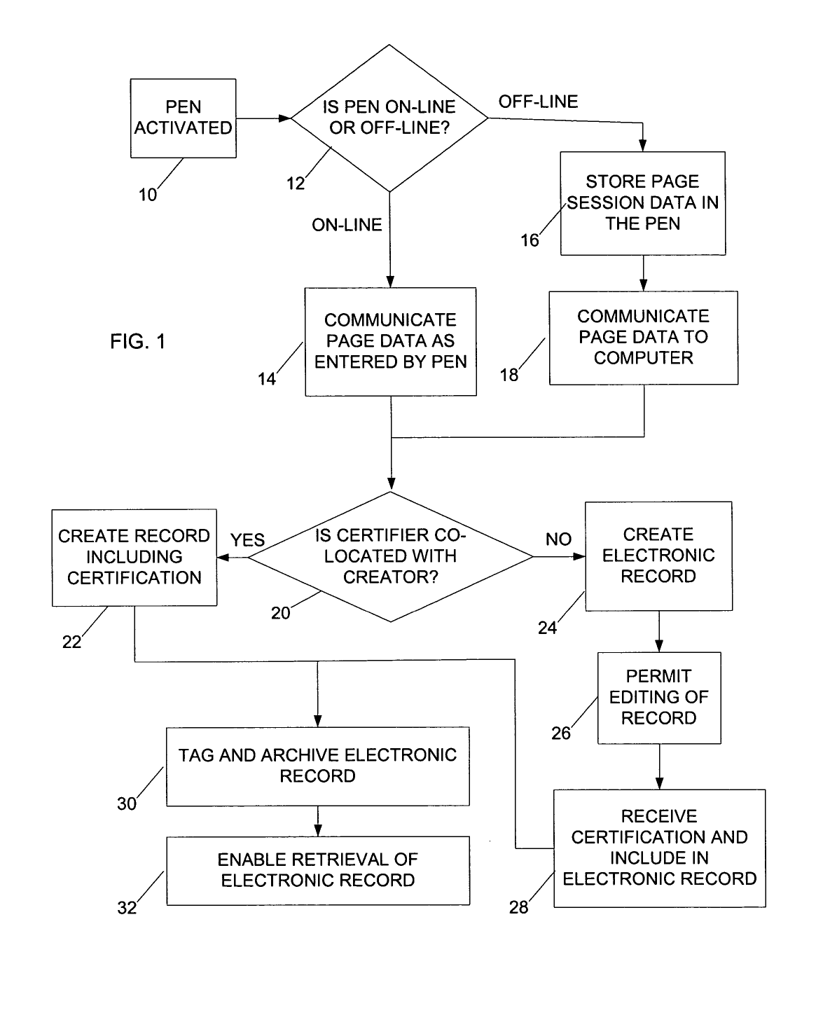

Turning now to the FIGURES that illustrate exemplary embodiments of the invention, FIG. 1 illustrates a flow diagram of exemplary operations in an intellectual property (IP) documentation system. Additional, fewer, or different operations may be performed in the IP documentation and processing method.

In an operation 10, a digital pen is activated. The digital pen preferably includes an ink cartridge and a digital camera scanning device. The digital pen includes a memory storage capacity. Preferably, this memory storage capacity is sufficient for at least a day of written images. The digital pen also includes a unique digital device identifier that is machine readable. This identifier is communicated along with electronically recorded information. The digital pen can upload information to a computer. Furthermore, the digital pen has a writing pressure sensing capability to record information associated with use of the pen while writing.

In an operation 12, a determination is made as to whether the digital pen is on-line or off-line. The digital pen can be on-line by having a current communication session in which the digital pen is in communication with another computing device. The communication connection can be wired communication or wireless communication. For example, the wireless communication can be carried out using Bluetooth or 802.11 wireless protocols.

If the digital pen is on-line, an operation 14 is performed in which writing information during a page session is sent directly to a receiving system as the inscribing is in progress. In an on-line session, the participants (e.g., the creator, certifier, and collaborator) are authenticated to work on the session. Once authenticated, participants can view the page session in real-time at remote locations because the session is being communicated and recorded onto a networked computer. Advantageously, in an exemplary embodiment, a collaboration session can be included by which more than person can view the page session and contribute to the work.

If the digital pen is off-line, operations 16 and 18 are performed in which page session data is stored locally in the digital pen and later communicated to a computer. By way of example, the digital pen can be coupled to a computer using a docking station and data previously stored is communicated to the computer.

In an off-line recording session, the creator begins a page session by affixing a date and time stamp to the page with the digital pen. The digital pen accumulates all inscriptions throughout the page session. In an exemplary embodiment, the page session can be interrupted and restarted until the creator affixes his or her signature on the page. When the signature is entered, the page session is stored on a read-only store and awaits the certifier signature.

In an operation 20, a determination is made as to whether a certifier is co-located with the creator. A certifier can be a witness, a reviewer, a manager, or any other person that can certify to what the creator has written. Co-location may be determined by use of the same input device and/or by input at a proximate date and time as the last input by the creator. If the certifier is at the same location as the creator and certifies the writing, the electronic record is created including the certification in an operation 22. Notably, a record created having a certification cannot later be modified, otherwise certification may not be accurate. As such, operation 22 creates a read-only record.

If the certifier is not co-located with the creator, an electronic record is created in an operation 24. In an operation 26, the electronic record created can be edited and annotated. Such editing and annotation can be done at a computer or using the input device. Editing and annotation can also be done at remote computers by people other than the creator. Advantageously, the creator and even others can add and/or remove information from the electronic record. In an operation 28, a certification is received and included in the electronic record. Once certification is received, editing and annotation of the electronic record can no longer be performed.

In an exemplary embodiment, page sessions and attached annotations can be encrypted and cross referenced to other page sessions. Preferably, uploaded page sessions can be edited and annotated only by the creator after sufficient authentication. URL annotations in the page are downloaded and attached to the page session with an as-of date and time stamp. Editing and annotating can occur during an on-line session using the digital pen or from a computer terminal when the electronic information has been communicated from the digital pen. As described, the signing of the page session by a certifier ends page session editing and annotation.

In an operation 30, electronic records are indexed or tagged by page sessions according to organization, subject, page type, creator, and any other variable. Additional tags can be defined based on content analysis of page sessions by any number of schemes, not limited to natural language processing, Bayesian statistics, neural networks, semantic networks, or conjoint analysis. In an exemplary embodiment, an ontology tag can be defined to describe the meaning of the contained key concepts.

Also in operation 30, the electronic records are archived. The archive can include main documents and attachments, indices, and taxonomies and other semantic structures. The main documents and attachments and corresponding indices are preferably kept on a non-modifiable medium or in a certifiably non-modified medium. Indices and taxonomies are preferably maintained in the archive to assist in the location and retrieval of stored documents. The taxonomies and other semantic structures can grow and change as the main documents and attachments grow in the archive.

In an operation 32, the retrieval of electronic records is enabled. In an exemplary embodiment, a user interface provides users at computers coupled to the archive with the ability to browse and retrieve documents and corresponding attachments by any text logical expressions on indices, taxonomies, and tags. A reporting facility permits the definition and maintenance of query expressions, specified orderings of documents, and formats for viewing the results. Advantageously, a working copy of the electronic record can be maintained to support analysis sessions and projects. Further, a log of all activity related to an electronic record is maintained.

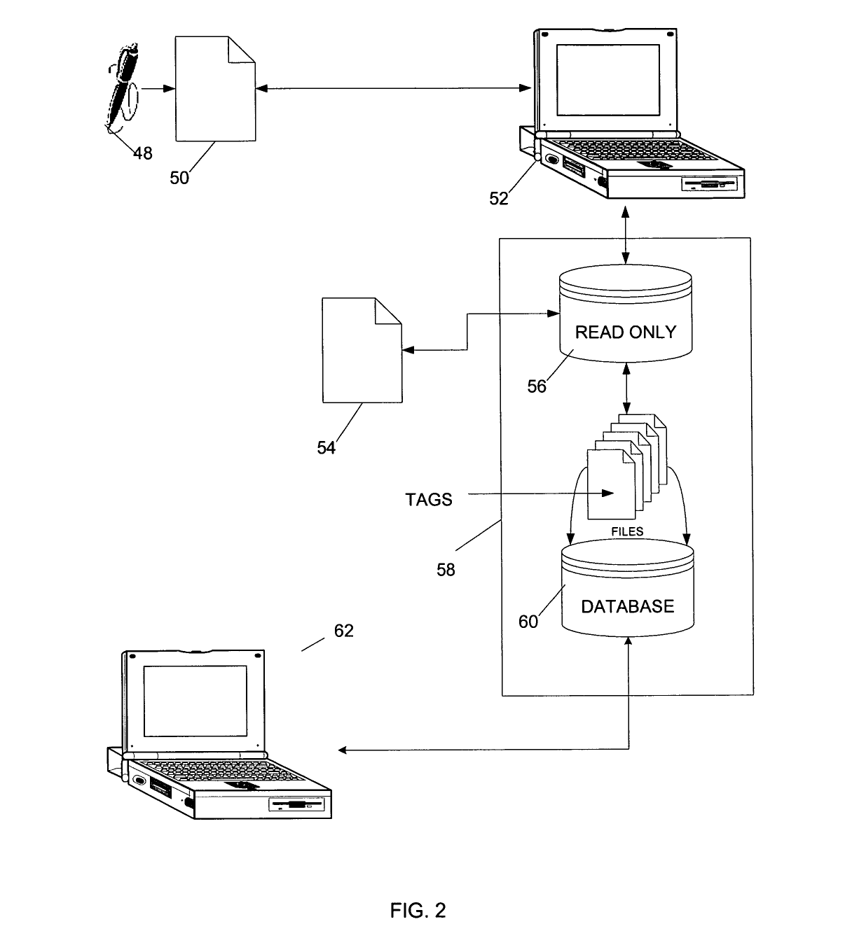

FIG. 2 illustrates a documentation system in which a digital pen 48 is used to generate an original page session hardcopy 50. Digital pen 48 electronically records the page session and communicates the electronic record to a computer 52. As described with reference to FIG. 1, the electronic recording process can be done either on-line or off-line, depending on the situation. Regardless of whether the process is on-line or off-line, an electronic record is taken at digital pen 48.

The electronic record can be edited or annotated until the record is certified and archived. A certification journal 54 records certification information, such as, time and date of the certification. Once the electronic record is certified, a read only electronic file is stored in a database 56 within a reliable and secure computer system 58. Tags and other indexing information can be included along with the electronic file and stored in a database 60. In an alternative embodiment, database 56 and database 60 are one database. Database 60 can be accessed after proper authentication procedures by a computer 62.

As discussed with respect to FIG. 1, editing and annotation operations can be performed before certification. Collaboration activities can also be performed before a certifier signature is received. Collaboration activities can involve the use of computers communicatively coupled to computer 52 via a network. As such, a collaborator can view electronic records in real time as the creator enters them during an on-line session. Preferably, computer system 58 is coupled to a network of computers such that access to collaboration sessions is possible before the electronic files are made read only and stored in database 60.

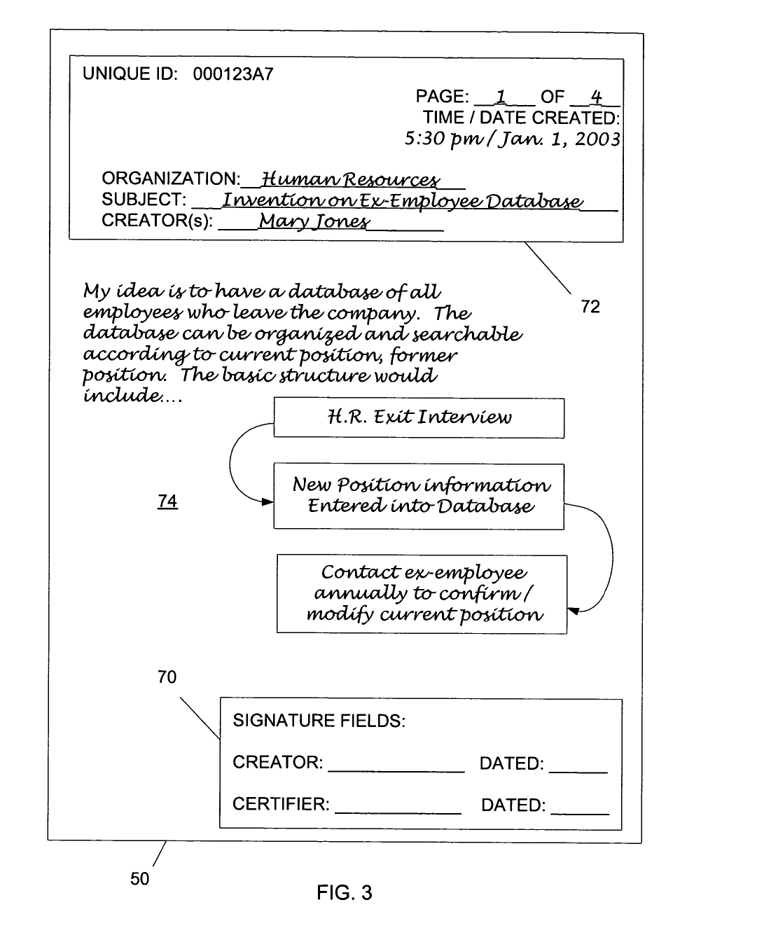

FIG. 3 illustrates hardcopy 50 including various page contents. These page contents are provided by way of example and not limitation. Hardcopy 50 includes signature fields 70 providing a location for the creator of the page and the certifier to sign and date. An information section 72 is also included in which a unique page identifier is given as well as locations for information regarding the organization, subject, page number, date/time created, and creator name. Information section 72 can include other information. Control indicators can be located as needed to signify universal resource locators (URLs) to annotation the written information on hardcopy 50.

A contents section 74 provides space for the creator to describe an innovation. The description can include written text, hand drawn figures, and any other information that helps describe the innovation. In an exemplary embodiment, the creator can annotate the description by including written text references to documents stored on a computer. For example, the creator can write: “For information on legal issues, see http://internal.company.com/˜legal/ex-employees.html.” The computer that receives the electronically recorded information from the digital pen can identify key phrases, such as, “http://” and establish links to documents identified after the key phrase.

Advantageously, the exemplary embodiments described herein provide integrity, privacy and non-repudiation for the information managed so that no unwarranted alterations are possible. No information is provided to the unauthorized and no interactions with the system can be denied by the agent that commits the interaction. Further, the exemplary embodiments provide the mechanisms necessary to support collaborative development of intellectual property in the form of authoring, reviewing, marking-up, retrieving and updating sets of documents. Yet further, the exemplary embodiments provide the mechanisms necessary to document intellectual property ownership claims in the form of evidentiary-quality information extracted from the document management system. As such, the system can satisfy regulatory compliance requirements (e.g., NASD).

In these exemplary embodiments, a computer system is used which has a central processing unit (CPU) that executes sequences of instructions contained in a memory. More specifically, execution of the sequences of instructions causes the CPU to perform operations, which are described above. The instructions may be loaded into a random access memory (RAM) for execution by the CPU from a read-only memory (ROM), a mass storage device, or some other persistent storage. In other embodiments, hardwired circuitry may be used in place of, or in combination with, software instructions to implement the functions described. Thus, the embodiments described herein are not limited to any specific combination of hardware circuitry and software, nor to any particular source for the instructions executed by the computer system.

While the exemplary embodiments illustrated in the figures and described above are presently preferred, it should be understood that these embodiments are offered by way of example only. Other embodiments may include, for example, different capturing techniques. Further, while some exemplary embodiments describe the invention in the context of intellectual property documentation, the invention may extend to other kinds of businesses or enterprises. The invention is not limited to a particular embodiment, but extends to various modifications, combinations, and permutations that nevertheless fall within the scope and spirit of the appended claims.

1. A method of simultaneously creating an electronic record of a hand-written document as the document is written and processing the electronic record within a computer system, the method comprising:
receiving electronic information relating to a document from a device, where the device creates the electronic information at the same time a hand-written record of the document is created, wherein the hand-written record of the document is created by a first party;
receiving certification information relating to the document and associated with a second party;
storing the electronic information relating to the document and the certification information in an electronic record; and
making the electronic record accessible for retrieval over a network.

2. The method of claim 1, wherein receiving electronic information relating to a document from a device comprises establishing a communication session between a computer and the device.

3. The method of claim 2, wherein the computer is coupled to a network of computers.

4. The method of claim 1, wherein receiving electronic information relating to a document from a device comprises creating an electronic file within the device wherein the electronic file includes the electronic information.

5. The method of claim 4, wherein the electronic information created at the same time the hand-written record of the document is created is communicated to a computer after the device has stored the electronic information and a communication session is initiated with the computer.

6. The method of claim 5, wherein communication session is initiated with the computer using a device docking station.

7. The method of claim 5, wherein communication session is initiated with the computer using wireless communication technology.

8. The method of claim 1, receiving certification information relating to the document and associated with a second party comprises receiving a certification file separate from the electronic information relating to the document.

9. The method of claim 1, further comprising preventing editing to the electronic information corresponding to the document after certification information relating to the document.

10. The method of claim 1, further comprising tagging the electronic record with search tags.

11. The method of claim 10, wherein the search tags are defined based on a content analysis of the electronic record.

12. A documentation system comprising:
a digital pen configured to dispense ink while also electronically recording writing information; and
a computer including:
programmed instructions to receive electronically recorded writing information from the digital pen and create an electronic document; and
programmed instructions operable to allow editing and annotations to the electronic document until certification information is received corresponding to the electronic document.

13. The documentation system of claim 12, wherein the digital pen initiates a page session including a date and time stamp and communicates information received in the page session to the computer.

14. The documentation system of claim 13, wherein the page session is interrupted and re-started.

15. The documentation system of claim 12, further comprising a user interface configured to enable searches of a database of a plurality of electronic documents.

16. The documentation system of claim 12, wherein the computer comprises programmed instructions to organize the electronic document using semantic structures.

17. The documentation system of claim 12, wherein certification information is received from a second digital pen, different from the digital pen.

18. An intellectual property documentation system comprising:
an inventor input device configured to write using a writing fluid and electronically record writing information;
a first computer operable to receive the electronically recorded writing information from the inventor input device and having programmed instructions configured to create an electronic record from the electronically recorded writing information, wherein the electronic record can be modified;
a second computer operable to communicate with the first computer, the second computer having programmed instructions to receive certification information and make the electronic record read only once the certification information is received, further the second computer having programmed instructions to index the electronic record for retrieval from a database; and
an interface in communication with the database such that a third computer can search a plurality of electronic records on the database and view a selected electronic record.

19. The system of claim 18, wherein the certification information is created using the same inventor input device and the first computer includes programmed instructions to receive certification information and make the electronic record read only.

20. The system of claim 18, wherein the certification information is created using a different inventor input device, the certification information being obtained from certification of a conditioned hard copy of the electronic record.

21. A system for simultaneously creating an electronic record of a hand-written document as the document is written and processing the electronic record within a computer system, the system comprising:
means for receiving electronic information relating to a document from a device, where the device creates the electronic information at the same time a hand-written record of the document is created, wherein the hand-written record of the document is created by a first party;
means for receiving certification information relating to the document and associated with a second party;
means for storing the electronic information relating to the document and the certification information in an electronic record; and
means for making the electronic record accessible for retrieval over a network.
